(19) United States
(12) Patent Application Publication
(10) Pub. No.: US 2023/0122309 A1
(43) Pub. Date: Apr. 20, 2023

(54) ELECTRONIC EAR-WORN DEVICE WITH THERMAL HAPTIC ELEMENTS

(71) Applicant: City University of Hong Kong, Hong Kong (HK)

(72) Inventors: Kening ZHU, Hong Kong (HK); Arshad NASSER, New Delhi (IN)

(21) Appl. No.: 17/966,896

(22) Filed: Oct. 17, 2022

Related U.S. Application Data
(60) Provisional application No. 63/256,622, filed on Oct. 17, 2021.

(51) Int. Cl. G08B 6/00

(52) U.S. Cl. CPC G08B 6/00

(57) ABSTRACT

In one aspect, the present invention provides a wearable device to convey notifications to the users with thermal haptic feedback including an earhook shell configured to be worn on a user's outer ear. The earhook shell including a plurality of thermoelectric modules for providing hot and cold stimuli at single or multiple points on an auricular skin area of the user's outer ear. A wireless receiver is provided for receiving communication signals from a computing device. A power supply electrically communicates with the plurality of thermoelectric modules and the wireless receiver.

### CROSS-REFERENCE OF RELATED APPLICATION

This present application claims the benefit of U.S. Provisional Patent Application No. 63/256,622 filed Oct. 17, 2021, which is incorporated by reference herein in its entirety.

### FIELD OF THE INVENTION

The invention relates to wearable haptic devices and, more particularly, to ear-mounted wearable haptic devices.

### BACKGROUND

With the increasing amount of information available in our daily life, various mobile and wearable interfaces have been proposed to improve the accessibility of digital data. Besides the common channels of information communication through visual and audio techniques, the tactile/haptic modality is receiving more and more attention. The vibrotactile feedback has been used for variety of applications including navigation and notifications/warnings. Also, the vibrotactile feedback has been tested individually and in combination/comparison with other modalities for notification on the move. However, sometimes it may be difficult for users to perceive the exact vibration location in the context of multi-point spatial vibrotactile feedback, as the natural turbulence or movements during walking or driving may affect the perception of vibration.

Besides the vibrotactile feedback, there is an increasing amount of research interest in recent years in the application of thermal feedback for human-computer interaction (HCI). Thermal feedback is usually silent and effective in noisy environments. The characteristics of single-spot and multi-spots thermal feedback have been investigated for mobile devices and smart wearable accessories (e.g., ear hook, headband, bracelet, and finger ring), with a reliable recognition accuracy for general purposes. In addition, the thermal feedback may be integrated on the steering wheel for notifying lane changes and directions in driving simulation. The spatial thermal feedback has also been used in the assistive device to provide navigation cues for visually-impaired people, showing the advantages of localization over the vibrotactile feedback.

The ear, as one of the body parts that are more sensitive to tactile feedback, has motivated the emerging research of wearable haptic devices. With the recent advancements in the Bearable technologies that focuses on the auditory output, many HCI researchers and analysts proposed ‘ear as the new wrist’, and started the research of wearable devices which could be worn on and around the ear and head. Research shows that the multi-point spatial vibrotactile feedback could be reliably perceived on the ear with the average accuracy over 80%. On the other hand, the on/around-ear (i.e., auricular) spatial thermal haptics for wearables is less explored when compared to the vibrotactile feedback. While thermal feedback has shown great potential in facilitating information representation, it is still unclear how it could be perceived as a wearable form factor as ear is one of the body parts that are very sensitive to temperature change.

Existing electronic travel aids for the hearing and visually impaired people provide audio instruction with the help of ear worn devices for navigational instructions. Some devices also address the issues of obstacle detection using the vibrotactile feedback. However, audio-based notification might be futile in an outdoor environment where the users rely on external audio cues especially in the case of visually impaired people. Studies have also shown that the vibro-haptic feedback could also underperform while a person is walking or moving.

Thus, there is a need in the art for improved wearable devices that provide haptic information in the region of the ear. Such devices could be used for visually-impaired or hearing-impaired users to notify them of various situations or guide them via GPS-based programs.

Thermal Feedback in HCI

As one early study on thermal feedback, Jones and Berris suggested a list of design recommendations for the thermal display based on psychological evidence. Some comprehensive research on thermal feedback in HCI has provided important insights such as: 1) hand is a body part with high thermal sensitivity; 2) the perception of thermal feedback could be strongly affected by clothes and the environment; 3) a set of thermal icons with an overall recognition accuracy of 83% may he designed using the rate and the direction of temperature change. More recently, researchers started investigating the spatial thermal feedback in wearable accessories and wide variety of applications, such as fingering, bracelet, headband, earhook, cane grip, etc. ThermOn was designed for users to feel dynamic hot and cold sensations on their body corresponding to the sound of music.

Multimodal Haptic Feedback on Wearable Devices

There are several wearable form factors that fit on, in or around the ear, providing audio playback, soundscape augmentation, or even integrate biometric sensors. However, haptic devices designed for the ear are relatively less explored. For example, Orecchio wearable device has experimented various static and dynamic auricular postures for extending the body-language, but with a focus on onlookers' perception of ear movement. Emoti-chair and the use of a vibratory earphone on the pinna used the vibratory sense to enhance the emotion of sound. Recently, Lee et al. developed ActivEarring to provide the spatial vibrotactile feedback on the ear. Their studies showed that the users can perceive a set of sequential vibrotactile patterns with an average accuracy over 80%. While the force-based and the vibrotactile feedback for wearable devices have started gaining more and more research interest, the thermal wearable is still under-explored. Recently, researchers presented the design of thermohaptic wearable display for the hearing and visually impaired users, by installing two miniature Peltier modules on each side of the eathooks. However, how users may perceive such auricular spatial thermal feedback is still unknown.

### SUMMARY OF THE INVENTION

The present invention integrates thermal haptic feedback in an earhook form factor for providing a wearable device. More specifically, the present invention provides a wearable device that can provide hot and cold stimuli at multiple points on the auricular skin area To investigate users' thermal perception around the auricular area, we developed three ThermEarhook prototypes with 3, 4, and 5 Peltier modules respectively. Different from most existing research that adopted the constant level of haptic signal for different users, our pilot study shows that the auricular thermohaptic threshold varies across the feedback locations and the users. With the user-customized thermohaptic signals around the ear, our first study suggested the selection of the ThermEarhook with four TEC modules on each side for further investigation, considering the users' identification accuracy (averagely 99.3%). We then conduct three follow-up studies to further evaluate users' perception of spatial thermal patterns with ThermEarhook, and finalize a set of multi-points auricular thermal patterns that can be reliably perceived by the users with the average accuracy of 85.3%. Lastly, we discuss the user-proposed potential applications of the thermal haptic feedback with ThermEarhook, such as gaming, music, navigation, mobile notifications, therapeutics, and so on.

In one aspect, the present invention provides a wearable device to convey notifications to the users with thermal haptic feedback including an earhook shell configured to be worn on a user's outer ear, the earhook shell including a plurality of thermoelectric modules for providing hot and cold stimuli at multiple points on an auricular skin area of the user's outer ear. A wireless receiver is provided for receiving communication signals from a computing device. A power supply electrically communicates with the plurality of thermoelectric modules and the wireless receiver.

In another aspect, the power supply, the wireless receiver, and the plurality of thermoelectric modules are mounted on a printed circuit board.

In another aspect, the wearable device further includes a controller in electrical communication with the power supply. The wearable device further includes the plurality of thermoelectric modules for controlling a temperature and a duration of the hot and cold stimuli.

In another aspect, the plurality of thermoelectric modules are Peltier modules,

In another aspect, the computing device is selected from a mobile phone, a personal computer (PC), a mainframe computer or a combination thereof.

In another aspect, the wearable device further includes a thermally conductive heat sink layer mounting the plurality of thermoelectric modules.

In another aspect, the wireless receiver is selected from one or more of NFC, Bluetooth, Wi-Fi module or any combinations thereof.

In another aspect, the power supply is a rechargeable battery.

in another aspect, the wearable device further includes one or more of a biosensor, a microphone, a bone conduction speaker, a GPS module, an accelerometer, and a gyroscope.

In another aspect, each of the plurality of thermoelectric modules is configured to be individually controlled by the controller.

In another aspect, the rechargeable battery includes connectors for external recharging.

In another aspect, the rechargeable battery is configured to be recharged through wireless recharging.

In another aspect, the plurality of thermoelectric modules includes two or more of the thermoelectric modules. Two or more of the thermoelectric modules are configured to be controlled together to create different thermal patterns.

In another aspect, the controller is configured to activate the thermoelectric modules for a duration ranging from 1-2 seconds through pulse-width modulation.

### BRIEF DESCRIPTION OF THE DRAWINGS

Embodiments of the invention are described in more details hereinafter with reference to the drawings and the patent of application file contains at least one drawing executed in color. Copies of this patent or patent application publication with color drawing(s) will be provided by the office upon request and payment of the necessary fee.

FIG. 1A shows an ear-mounted wearable device according to an embodiment.

FIG. 1B shows an ear-mounted wearable device with 3, 4, and 5 thermoelectric modules.

FIG. 2 depicts miniature Peltier modules that may be used with the ear-mounted wearable device.

FIG. 3 depicts a test set up with a user wearing the device of FIG. 1A.

FIG. 4 depicts PWM values for hot and cold feedback for various positions on the earhook. The error bars indicate standard deviations.

FIG. 5A shows GUIs of left ear for Study 1. FIG. 5B shows GUIs of right ear for Study 1. FIG. 5C shows multi-points thermal patterns for Study 2, 3, & 4.

FIG. 6A shows the accuracy (%) of 3 thermoelectric (IEC) Configuration for Study 1. FIG. 6B shows the accuracy (%) of 4 TEC Configuration. FIG. 6C shows the accuracy (%) of 5 TEC Configuration.

FIG. 7A shows the confusion tables of 3 TEC configuration for Study 1. FIG. 7B shows the confusion tables of 4 TEC Configuration. FIG. 7C shows the confusion tables of 5 TEC Configuration. Rows represent stimulated pattern and columns the participants' input.

FIG. 8 is the response time for Study 1. The error bars indicate the standard deviations.

FIG. 9 show thermal icons of left ear for Study 2; right ear for Study 2; and both ears for Study 3. (h: hot stimuli, c: cold stimuli).

FIG. 10A shows the descriptive results of the identification accuracy of left ear for Study 2. FIG. 10B shows the descriptive results of the identification accuracy of right ear for Study 2. FIG. 10C shows the descriptive results of the identification accuracy of both ears for Study 3.

FIG. 11A shows the confusion tables of left ear for Study 2. FIG. 11B shows the confusion tables of right ear for Study 2. FIG. 11C shows the confusion tables of both ears for Study 3. Rows represent stimulated pattern and columns the participants' input. The error bars indicate the standard deviations.

FIG. 12 is the response time for Study 2. The error bars indicate the standard deviations.

FIG. 13 shows selected spatial thermal icons (h: hot stimuli, c: cold stimuli),

FIG. 14 is the accuracy (%) of Study 4.

FIG. 15 is the confusion table for Study 4.

FIG. 16 is the response time for Study 4. The error bars indicate the standard deviations.

### DETAILED DESCRIPTION

Thermal Sensitivity around the Auricular Area

Early research on the temperature sensitivity of the body surface shows that the forehead and the cheek have the lowest hot and cold threshold. Recently, it has been reported that the ear and its surrounding areas also possess a low thermal threshold, indicating high sensitivity to thermal variations. Treede et al. found that hairy skin is more heat sensitive than a glabrous skin portion (that is, skin without hair). Recent research on the on-finger thermal feedback supports this finding of the difference on the thermal sensitivity between hairy and glabrous skins. As the hair and the skin thickness vary around the ear, it is reasonable to hypothesize that different areas around the ear may yield different thermal sensitivities, making it non-trivial for designing auricular thermal patterns.

Thermal Earhook Design

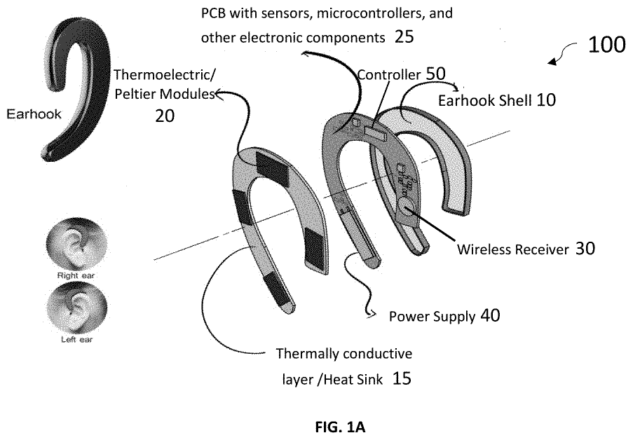

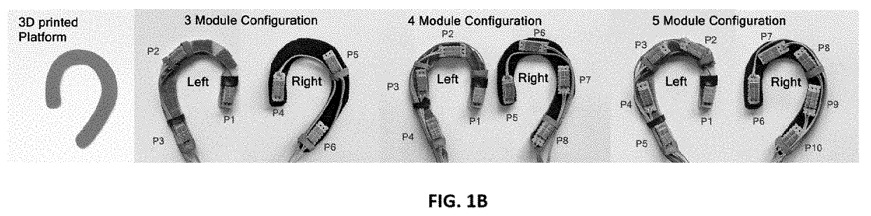

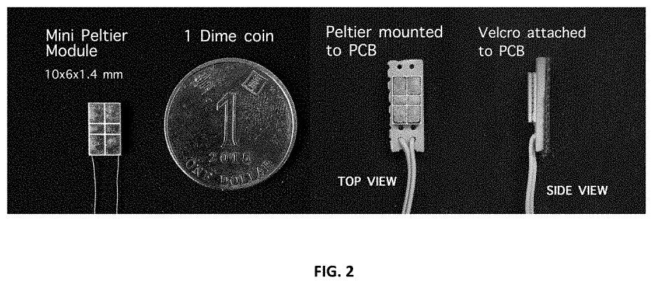

FIG. 1A schematically depicts an ear-mounted wearable device for providing thermal stimuli to a user in the region surrounding the outer ear. The device can provide various thermal patterns on the surface depending on the input or pre-set parameters. The user wearing the earhook can feel thermal feedback on single or multiple points on the auricular areas. Different levels of notifications with distinct intensities and patterns (optionally predetermined by the users) corresponds to the signals received from the connected external devices. These patterns may be helpful to guide the users with their navigation directions, alarms and other electronic notifications as, for example, by a smartphone, laptop, or other electronic device.

Turning to FIG. 1A, a wearable device 100 is provided to convey notifications to users with thermal haptic feedback. The device includes an earhook shell 10 configured to be worn on a user's outer ear. The earhook shell includes plural thermoelectric modules 20 for providing hot and/or cold stimuli at multiple points on an auricular skin area of the user's outer ear. A wireless receiver 30 is provided for receiving communication signals from a computing device (not shown in FIG. 1A). A mobile phone, a personal computer (PC), or a mainframe computer may provide communication signals to notify the user of information such as directions supplied from a navigation program where the thermal stimuli tell the user to turn right or left, for example,

A power supply 40 is in electrical communication with the thermoelectric modules 20 and the wireless receiver 30. The power supply may be a single use battery or rechargeable battery and may include connectors for external recharging; alternatively, the rechargeable battery may be recharged through wireless recharging. The wireless receiver may be the wireless receiver may be one or more of NEC, Bluetooth, or Wi-Fi modules.

A controller 50 may be provided that is in electrical communication with the power supply and the plurality of thermoelectric modules for controlling a temperature and duration of the hot and cold stimuli. Each of the thermoelectric modules may be individually controlled by the controller; two or more of the thermoelectric modules may be controlled together to create different thermal patterns.

The wearable device can additionally include one or more of a biosensor, microphone, bone conduction speaker, GPS module, accelerometer, or gyroscope. As seen in FIG. 1A, a thermally conductive heat, sink layer 15 may be used to mount the thermoelectric modules. The power supply and wireless receiver may be mounted on a printed circuit board 25 beneath the plurality of thermoelectric modules on heat sink layer 15.

The thermal earhook design uses the form factor of earhook over the circular ear pad, as seen in FIG. 1B; earhooks are used as a common form of not only audio and verbal communication, but also as assistive devices for people with hearing impairments. In the depicted ThermEarhook, as an example, 10×6 mm thermoelectric modules (i.e., Peltier modules) are employed with a thickness of 1.4 mm (Model No.: TES1-03103), as shown in FIG. 2. The thermo-electric element includes a matrix of micro Peltier elements with a metallized surface. The modules are selected because of their thinness, light weight, and a manufacturing process that offers a high thermal efficiency (maximum refrigerating capacity Qmax=7.51) even without a heat sink.

The exemplary earhook frame of FIGS. 1A-1B is 3D printed with PLA (Polylactic Acid) having a thickness of 1.2 mm. The sizing was selected to allow slight flexibility to fit the uneven surface around the back of the ear. The miniature size of the thermoelectric module also facilitates the fitting of the ThermEarhook on the skin around the auricular area.

The setup of ThermEarhook is as shown in FIGS. 1A-1B. All the Peltier modules are driven using a custom-designed H-bridge driver module (Model No.: L298N) shield and an Arduino Mega micro-controller, with an external switching mode power supply. Each Peltier module draws a maximum of 400 mA at 6V during the stimulation. The system was controlled by the Arduino Mega connected to a laptop through USB, to ensure the fine control of the temperature through Pulse Width Modulation (PWM Thermal stimuli was activated for approximately 1.5 s (on for approximately 1.5 s and then switched off), for a comfortable yet perceivable temperature feedback. With the full duty cycle of PWM (255), the Peltier module can change its surface temperature with the temperature-changing rate of 3.5° C./s, increase/reduce 5.25° C. within 1.5 s. The duty cycle mainly controls the changing rate. The range of temperature depends on the user's skin temperature. Given the changing rate of 3.5° C. per second and the skin temperature of 35° C. the range of temperature after 1.5 s would be 29.75-40.25° C.

The present invention can output thermal feedback to auricular areas behind the ear based on selected predefined thermal patterns. The thermal feedback mechanism is based on the Peltier effect. The thermal feedback (hot and cold) may be achieved with the help of the several “couples” of bismuth telluride dices (may be effectively called as a Peltier modules) or, in the alternative, other materials with a high thermoelectric effect, that are layered on one side of the earhook device.

### EXAMPLES

Psycho-physical research shows that as different skin parts have different thermal thresholds, so do different people. To this end, a preliminary investigation was performed before the examples set forth below of multi-spots thermal feedback, to understand the thermal threshold of various points around the auricular skin area for different persons. The results of the pilot study provided the practical guidance for the final configuration. 10 participants (5 male and 5 female) aged from 25 to 35 years old (Mean=31.5, SD=4.42) were used. The average skin temperature on the auricular area was 33.2° C. and the average room temperature was 27.3° C.

Apparatus

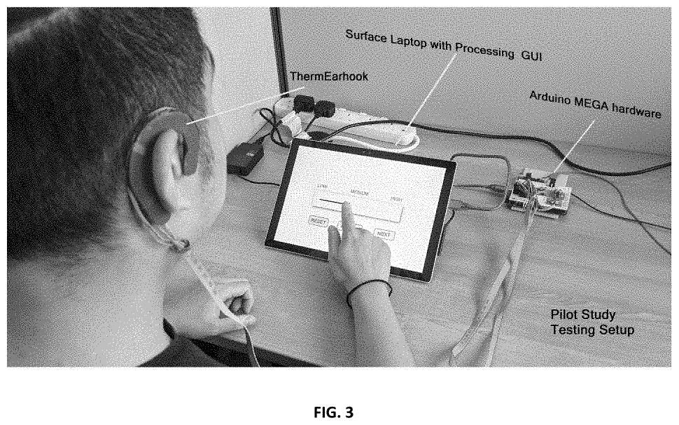

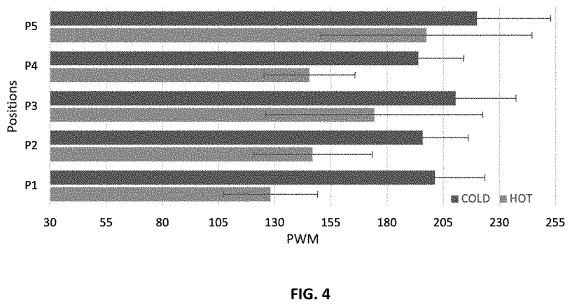

A 3D-printed earhook frame with five Peltier modules was used for the pilot study. An Arduino-based thermal control system for the earhook was connected to a Surface Pro laptop through a USB cable. A processing-based graphical user interface (GUI), as shown in FIG. 3 allows the participant to adjust the hot and the cold stimuli to a perceivable and comfortable level for each of the five points on the earhook. This information is then stored as a text file in the laptop.

Procedure and Task

There is one experimenter and one participant in each experiment session. Upon the arrival of the participant, the experimenter briefly introduces the purpose and the flow of the study. The experimenter first measured the participant's skin temperature around the auricular area and collected biographic information. He then demonstrated how to wear the earhook on the left ear and then assisted the participant to wear it. The experimenter verbally explained the nature of each stimulation to familiarize the participant with the stimuli. During the explanation, the experimenter numbered the position of the stimulus corresponding to the GUI shown on the screen FIG.3. With each thermal stimulus (hot and cold) lasting for 1.5 s, the participants were presented in a clock-wise order with the front position (P1 in FIG. 1B) of the earhook as the start. A slider on the GUI allows the participant to select the PWM values, ranging from 0 to 255, to control the intensity of the thermal stimulus. The participant could slide it freely and repeat the current stimulus until satisfied and then move to the next position. For the PWM adjustment, the participant is instructed to find the intensity that he/she feels is the most comfortable and perceivable.

Results and Analysis

The PWM values were adjusted by the participants as the dependent variable, the location of the Peltier module and the direction of temperature change as the within-subjects independent variables, and the gender as the between-subjects variable. The repeated-measures ANOVA showed that in the data, the user-defined PWM values were significantly affected by the location of the Peltier module (F(4,32)=6.07, p<0.005, η2=0.431) and the direction of temperature change (F(4,32)=6.07, p<0.005, η2=0.431). There is no interaction effect between the location of the Peltier module and the direction of temperature change. FIG. 4 shows the PWM values chosen by the participants for five points on the earhook, with the location P1 yielding the lowest average PWM value chosen by the participants. Post-hoc pairwise comparison showed that the PWM values for P5 was significantly higher than those for P1 (p<0.005), P2 (p<0.05), and P4 (p<0.05). In addition, the PWM values for the cold stimuli were significantly higher than those for the hot stimuli (p<0.0005), consistent with current research results showing humans have a lower thermal threshold for heat than for cold. Gender-wise, there was a significant difference between the PWM values chosen by the female and the male participants. Female Average: 170.15 (SD=45.74); Male Average: 196.77 (SD=43.46))

Based on the pilot-study results, it is reasonable to assume that different users will prefer different levels of thermal intensity for different spots around the auricular area. This further indicates a need to allow the users to customize the thermal signals in the following experiments.

Study 1: Single-Point Thermal Perception Around the Aruicular Area

To investigate the spatial acuity of perceiving single-point stimuli and determine the optimal multi-point layout, it is first investigated how users would perceive a single-point thermal feedback around the left and right ears.

Participants

Twelve participants (10 male and 2 female) ranging in age from 23 to 30 years old (Mean=26.5, SD=42.42) were recruited. None of them participated in the pilot study. The average room temperature was 30.3° C. Average skin temperature around the auricular area was 33.6° C.

Apparatus

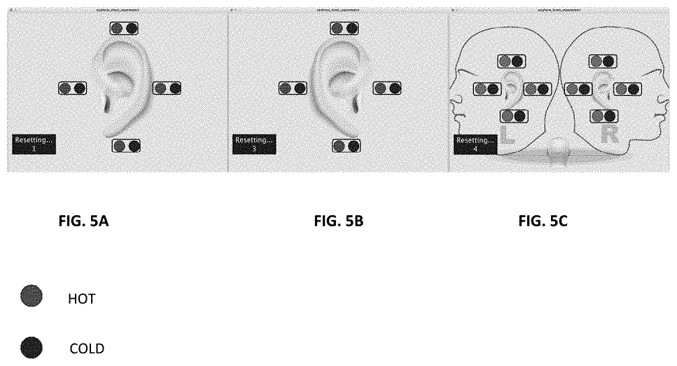

Three pairs of 3D-printed earhooks (for left and right ears) were used which have three configurations of three, four, and five Peltier modules respectively, as shown in FIG. 2. The Arduino-based thermal control system for the earhook was connected to a laptop through a USB cable. A processing-based graphical user interface (GUI) was developed, as shown in FIG. 5, for triggering the stimuli and registering the participants' responses, The GUI ran on a Microsoft Surface Pro with touch screen.

A within-subject study was designed with the configuration (i.e., the number) of the Peltier modules (3, 4, and 5), the side of the ear (left or right) and the directions of temperature change (hot and cold) as the independent variables. The dependent variables included the accuracy and the response time of stimuli perception. Here we define the response time as the time duration between the end of the stimulus and the timestamp when the participant makes his/her choice on the touch screen. Since the GUI pops up after the 1.5 s stimuli, the participant could be notified when one stimulus ends as the selection buttons show up. For each combination of the module configuration and the side of ear, the participants were instructed to choose a just noticeable yet comfortable thermal intensity by adjusting the PWM value for each of the Peltier modules before starting the experiment.

The order of the module configuration and the ear side were counter-balanced using the Latin Square method, splitting into 2 ears 3 configurations=6 sessions, for each participant. The locations and the directions (hot/cold) of the stimuli were randomly presented within each combination of the module configuration and the side of ear. Each stimulus is repeated thrice, resulting in 2 ears (left and right)×(3+4+5) module positions×2 directions of temperature change×3 repetitions=144 trials for each participant.

Procedure and Task

Each experiment session involved one participant and one experimenter at a time, and consisted of one training block and one testing block. Upon the arrival of the participant, the experimenter introduced the procedure of the experiment, collected the participant's biographical information, and demonstrated the ThermEarhook prototype. In each session, the participant was first assisted to wear the pair of ThermEarhook prototypes on both his/her ears. The thermal stimuli were then activated, starting from P1 to P3/4/5 on the same side, with the corresponding point highlighted in GUI. Each stimulus lasted for 1.5 s. Meanwhile, the experimenter verbally explained the position of the stimulus and the nature of each stimulation to familiarize the participant with the stimuli. The participant could choose to repeat the current stimulus for training or move to the next one by verbally reporting to the experimenter.

After training, the participant started the testing block, where the stimuli were presented in a randomized order. The selection interface was displayed after each stimulation. The participant was also instructed to make a respective selection on the touch screen as fast as possible once he/she felt and confirmed the stimulus. The timestamp of the participant making the selection on the screen was used to calculate the response time. There was a 7 s break between two consecutive stimuli. Between two experiment sessions, a temperature-resetting and resting period of 5 minutes was given to the participant. A short semi-structured interview was conducted at the end of the experiment to collect the participant's subjective comments on his/her experience of ThermEarhook. The overall experiment duration per participant was approximately one hour.

Results:

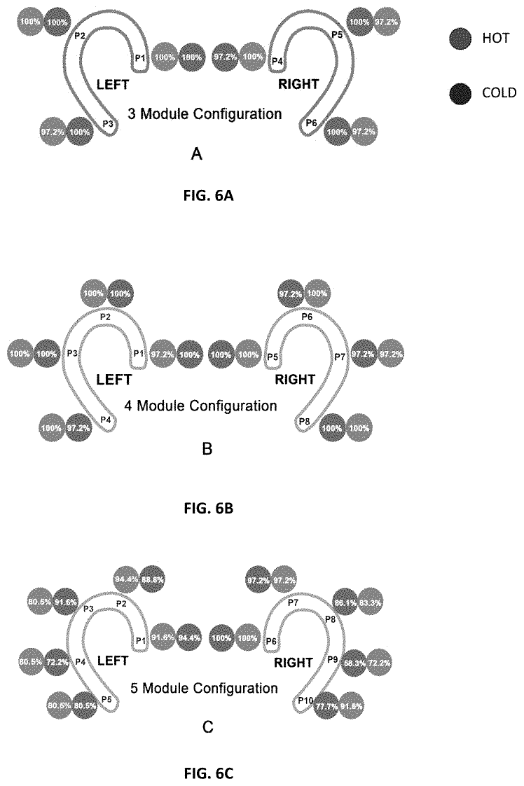

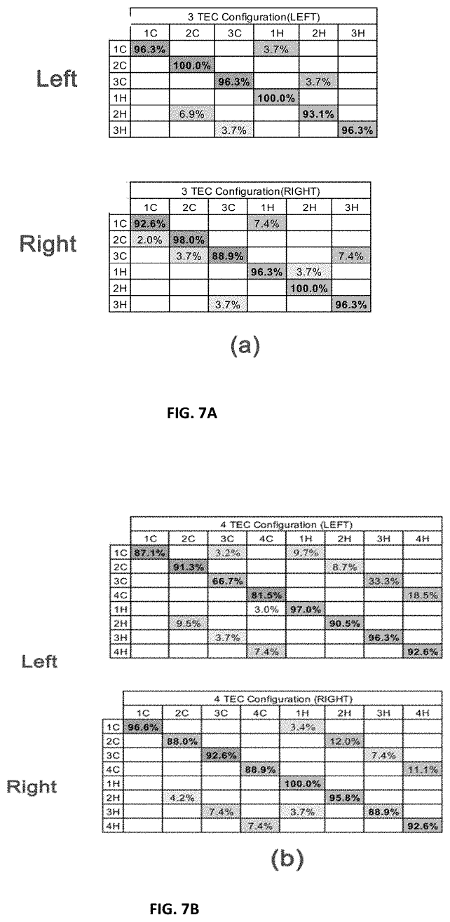

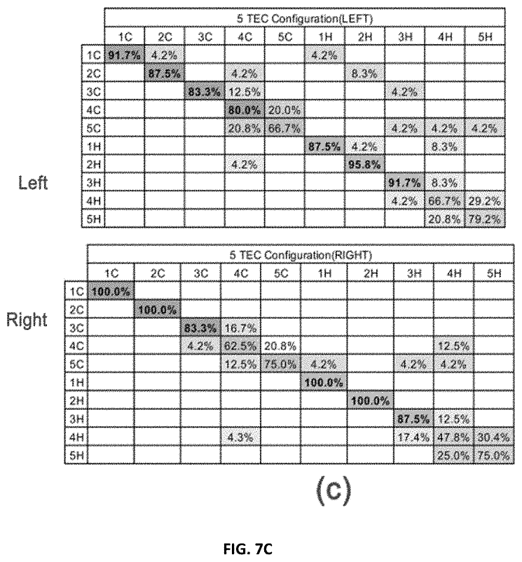

Accuracy: The repeated-measures ANOVA (RM-ANOVA) show that the accuracy of element identification was p significantly affected by the number of Peltier modules (F(2,22)=81.83, p<0.0005, η2=0.882), while there is no significant effect of the side of ear (p=0.817), nor the direction of temperature change on the accuracy (p=0.670). The post-hoc pairwise comparison reveals that the five-module configuration yielded significantly lower accuracy than the three- and the four-module configurations (3 vs 5: 99.1% vs 86.0%, p<0.0005, 4 vs 5: 99.1% vs 86.0%, p<0.0005), with no significant difference between the three- and the four-module configurations (p=0.923). FIG. 6 shows the accuracy of individual stimuli identification, and FIG. 7 shows the confusion tables in different thermoelectric (TEC) configurations.

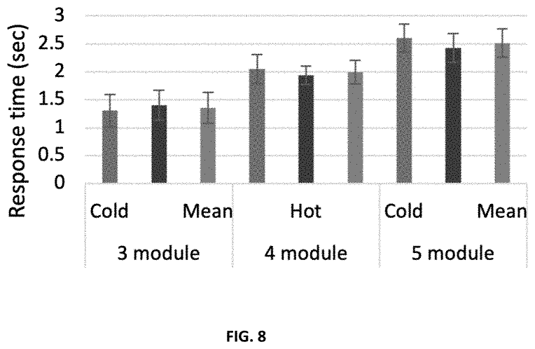

Response Time. The multi-factorial repeated measures ANOVA revealed the significant effect of the configuration on the participants' response time to the stimuli (F(2,22)=11.53, p<0.005, η2=0.512). Post-hoc Boferroni test showed that the 5-modules configuration yielded significantly longer response time than the 3-modules configuration (p<0.005) and the 4-modules configuration (p<0.05), and there was no significant difference between the response time for the 3-modules and the 4-modules configurations. FIG. 8 illustrates the descriptive results of the response time for different temperature-change direction and configurations.

In general, Study 1 showed that the user performance of locating auricular thermal feedback was affected negatively by the number of the Peltier modules in the ThermEarhook device. This aligns with existing research results that spatial acuity reduces with a reduction in the distance between two thermal stimuli. While the three-modules configuration resulted in the best performance of locating the single-point thermal feedback, it was determined to use a four-modules configuration, of which the accuracy and the response time have minor differences with the three-module configuration for further study. This was mainly due to the higher expressiveness for communication with more Peltier modules. With the selection of the four-module ThermEarhook, the multi-factorial RM-ANOVA showed that there is no significant effect of the location of the thermal stimulus or the direction of the temperature change on the accuracy and the response time of identifying the feedback location.

Designing Spatial Thermal Haptic Patterns Around the Auricular Area

Study 1 confirmed that users can reliably perceive the individual thermal stimulation with a 4-modules setting. To gain a deeper understanding on the affordance and the expressiveness of the 4-TEC setting, new spatial thermal patterns were configured by combining a pair of single-point thermal stimuli on the same ear and two different ears. The following dimensions were selected for the auricular spatial thermal patterns design:

Temperature Direction {Hot—h, Cold—c}

Location {Front: P1 & P5, Top: P2 & P6, Back: P3 & P7, Bottom: P4 & P8}

Grouping Strategy {Different locations around the left ear, Different locations around the right ear, Same location on two different ears} (for patterns involving two Peltier modules)

Temporality {Simultaneous} (for patterns involving two stimuli, controlled)

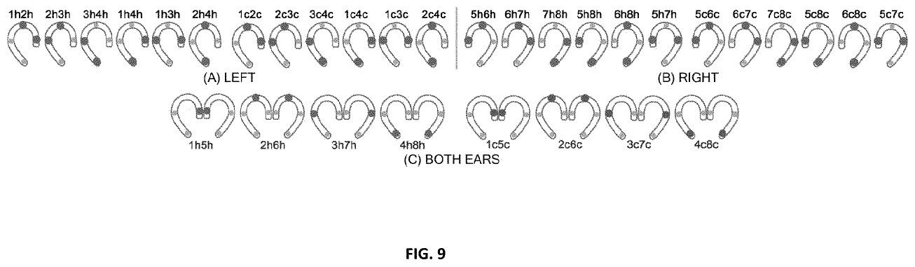

The aforementioned design dimensions result in three groups of spatial thermal patterns: left-ear patterns (FIG. 9a), right-ear patterns (FIG. 9b), and two-ears patterns (FIG. 9c). Each group could be further divided into two groups: hot and cold, according to the direction of temperature change. To facilitate the data analysis, the thermal pattern was coded based on the locations of the individual stimuli and the direction of temperature change. For example, the pattern 1h2h indicates the pattern that the front and the top modules on the left side are triggered with the hot stimuli, while 5h6h indicates the similar pattern but on the right side. The pattern 1c5c indicates that the front modules on both left and right sides are triggered with the cold stimuli,

Study 2: Multi-Point Thermal Patterns With One Ear

With the multi-spot auricular thermal patterns in FIG. 9a and b, Study 2 was conducted to determine how accurately and fast the users could recognize these spatial thermal patterns that only involve the spots around the same ear.

Participants

12 participants (3 female and 9 male, average age 25 years old) were selected from a local university where none of the participants had previous experience with thermal haptics. The average auricular skin temperature was 32.3° C. (SD=1.8). The room temperature was controlled at 24° C.

Apparatus

Based on the design of the auricular thermal icons, the four-Peltier ThermoEarHook device was used for the study, and used the same temperature control mechanism and hardware as those used in Study 1.

Study Design

A within-subjects evaluation was performed with the side of the ear, the direction of temperature changing, and the type of pattern as the independent variables. The dependent variables were the accuracy and the response time of the stimulus. The order of the two stimuli sets (i.e., left ear, and right ear) was presented in the Latin-Square counter-balanced order, resulting in two sessions for each participant. The stimuli within each set were presented thrice in a randomized order, so there were (12 on the left ear+12 on the right ear) patterns with 3 repetitions=72 trials for each participant. There was a 7-second gap between two consecutive cues, and a 5-minute break after one set of stimuli. Each participant went through the procedure of training and testing similar to Study 1.

Results: Accuracy & Response Time

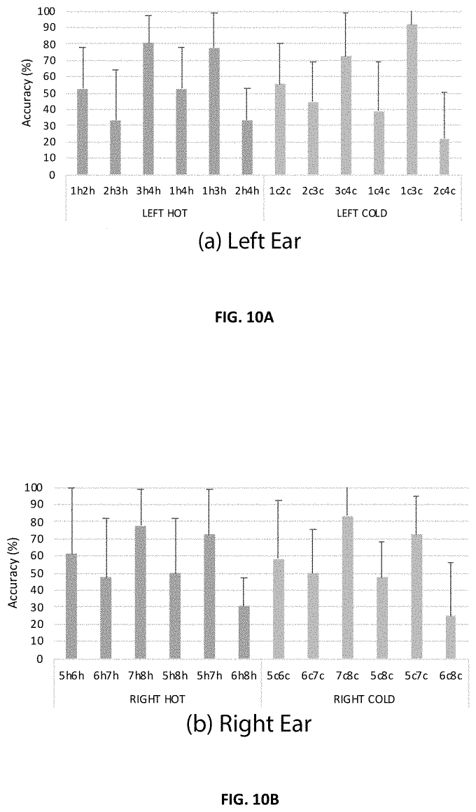

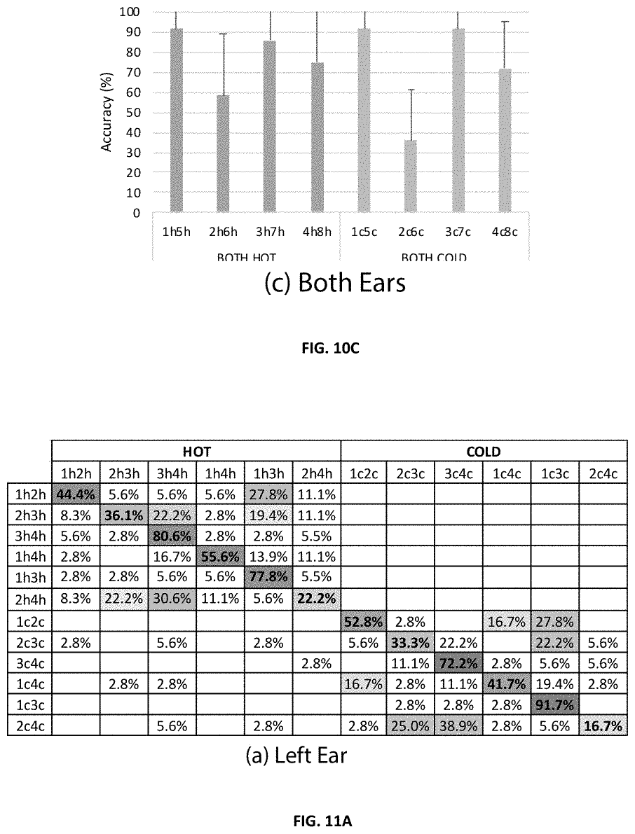

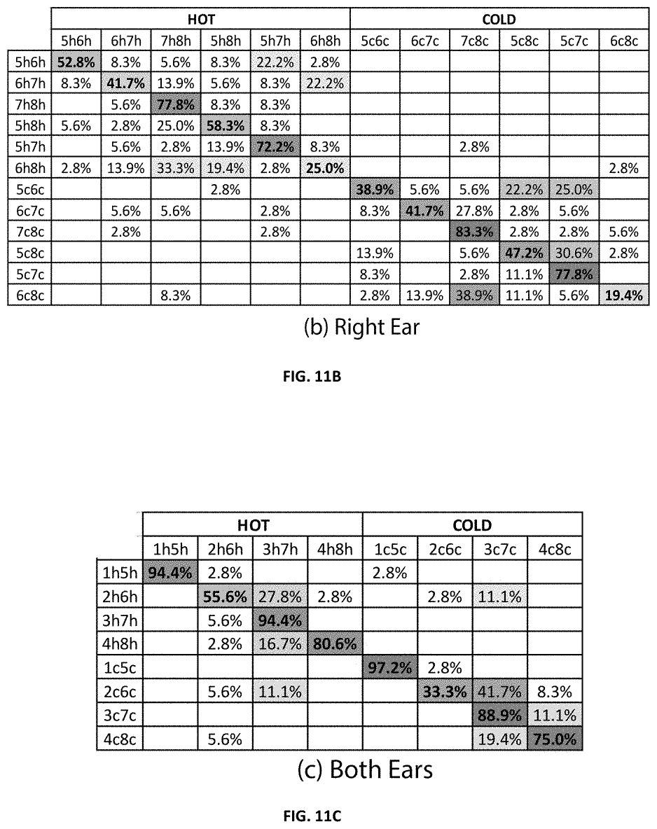

Accuracy. A multi-factorial repeated measures ANOVA was performed on the accuracy of recognizing the one-ear thermal patterns. The results showed that there was a significant effect of the type of pattern (F(5,55)=16.19, p<0.0005, η2=0.595), but no significant effect of the ear side or the direction of temperature changing. Post-hoc pairwise comparison showed that 1h3h and 3h4h yielded significantly higher accuracy than the other hot patterns on the left side (p<=0.0045), and so did 5h7h and 7h8h on the right side (p<=0.032). Similar results were found in the cold stimuli, with 1c3c and 3c4c being significantly more accurate on the left side, and 5c7c and 7c8c yielding significantly higher accuracy on the right side. FIGS. 10a and 10b depict the average accuracy of stimuli identification for each pattern on the left and the right ears. FIGS. 11a and 11b show the confusion tables for the left and the right sides respectively.

Response Time.

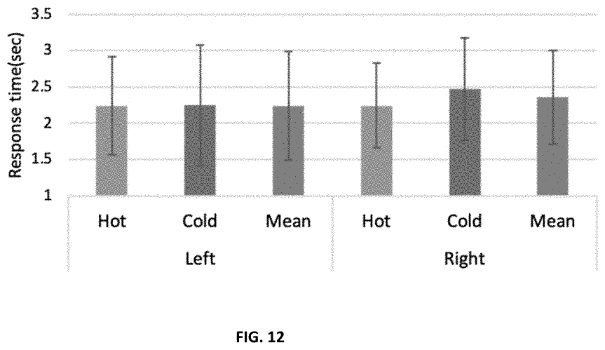

The overall average response time for the multi-point thermal patterns around one ear is 2.30 seconds (SD=0.72). A repeated measures ANOVA revealed there is no significant effect of the side of ear on the participants' response time. Also, there was no significant effect of the direction of temperature change on the response time, nor the pattern type. FIG. 12 illustrates the response time for different temperature-change directions and different sides of ear.

Discussion of Study 2

Six same-ear spatial patterns were found with over 70% accuracy: 1h3h, 3h4h, 1c3c, 3c4c, 5h7h, 7h8h, 5c7c, and 7c8c. All these patterns involve the back location in the ThermEarhook prototype. This could be due to the thin skin at the back around the ear leading to a high thermal sensitivity, as existing psycho-physical research shows that the thickness of the skin is negatively correlated to the thermal sensitivity. In addition, half of these more accurate patterns involves the front location (i.e., 1h3h, 1c3c, 5h7h, and 5c7c). This could be due to the high thermal sensitivity of the hairy skin in this area. However, as the thickness of the hairy layer increases at the top location of the ThermEarhook device, the thermal stimuli were mostly blocked by the hair, resulting in the lower accuracy (averagely 35.4%) for the patterns involving the stimuli in this area (i.e., 1h2h, 2h3h, 2h4h, 1c2c, 2c3c, and 2c4c on the left; 5h6h, 6h7h, 6h8h, 5c6c, 6c7c, and 6c8c on the right).

Study 3: Multi-Point Thermal Patterns With Both Ears

Besides the spatial thermal patterns around one ear only, it is also possible to design the patterns by combining the spots on both ears. To this end, we conducted the third study to investigate how accurately and fast users may recognize the two-ears spatial thermal patterns as shown in FIG. 9c.

Participants

12 participants (6 female and 6 male, average age 25.2 years old) from a local. university were used where none of the participants had previous experience with thermal haptics. The average skin temperature was 32.4° C. (SD=1.2). The room temperature was controlled as 25° C.

Apparatus

The same apparatus was used as those used in Study 2.

Study Design and Procedure

Similar to Study 2, a within-subjects study was designed, taking the direction of temperature change and the type of pattern as the independent variables, and the recognition accuracy and the response time as the dependent variables. For each×participant, the order of the both-ears thermal patterns was randomized, and each pattern was repeated thrice. There were 4 patterns 2 directions of temperature change 3 repetitions=24 trials for each participant. In addition, each participant went through the similar procedure of training and testing as the ones in Study 2.

Results: Accuracy & Response Time

A multi-factorial repeated measures ANOVA showed that there was a significant effect of the type of pattern (F(3,33)=13.28, p<0.005, η2=0.547), but no significant effect of the direction of temperature changing. Post-hoc pairwise comparison showed that within the hot stimuli, 2h6h yielded significantly lower accuracy (55.6%) than the other three hot stimuli (i.e., 1h5h: 94.4%, 3h7h: 94.4%, 4h8h: 80.6%. p<=0.0023). Similar results were found in the cold stimuli, with 2c6c resulting in significantly lower accuracy (33.3%) than the others (i.e., 1c5c: 97.2%, 3c7c: 88.9%, 4c8c: 75.0%. p<=0.00042). For the response time, there is no significant effect of the type of pattern or the direction of temperature change, with an overall average value of 2.6 seconds (SD=0.71).

Discussion of Study 3

A similar trend was observed of user performance in Study 3 as the one in Study 2. The two-ears patterns with the front locations (with thin hair) and the back locations (with thin skin) yielded higher accuracy than the rest of the patterns did. These results are consistent with the existing psychophysical studies on the thermal sensitivity of human beings as mentioned above.

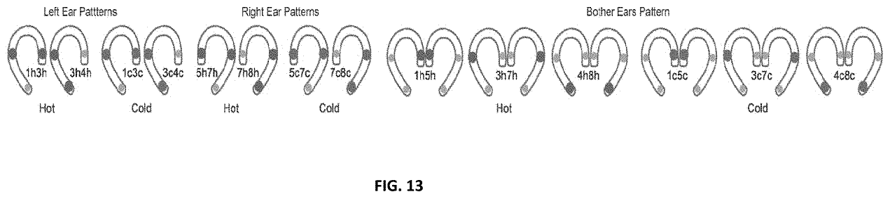

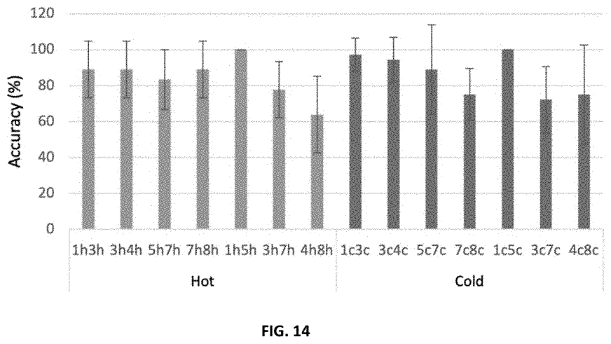

According to the results of Study 2 and 3, in total fourteen spatial thermal patterns were selected as shown in FIG. 13, as the set of spatial thermal icons for ThermEarhook. The average accuracy for the users recognizing the chosen one-ear multi-points thermal patterns was 80.2%, and 88.4% for the two-ears patterns. Overall, the two-ears patterns are more accurate than the one-ear ones, as the increased distance between the two individual stimuli for the two-ears patterns improve the spatial acuity for thermal perception.

Study 4: Evaluating the Chosen Set of Spatial Thermal Patterns

While Study 2 and 3 found a set of hot and cold thermal patterns/icons with considerable identification accuracy, they are tested in separated sessions. It is still unknown how accurate humans can perceive the patterns when testing them all together. In Study 4, these two-point simultaneous thermal patterns were tested together, to investigate the feasibility of using them together as a set of thermal icons.

Participants

We recruited another 12 university students who didn't have any prior experience with thermal haptics (4 female and 8 male, averagely aging 26.7 years old). The average skin temperature was 32.2° C. (SD=1.5). The ambient indoor temperature was controlled to be 25° C.

Apparatus

The same apparatus as those used in Study 2 and 3 was used.

Study Design

A within-subjects evaluation was designed with the direction of thermal change and the pair of spots involved in the spatial thermal patterns as the independent variables. The dependent variables were the accuracy and the response time of users perceiving the thermal patterns. All the patterns were repeated thrice and presented in a randomized order, resulting in 7 pairs of spots with 2 directions of temperature change at 3 repetitions=42 trials for each participant. There was a 7-second gap between two consecutive cues. Each participant went through the similar procedure of training and testing as the ones in Study 2 and 3.

Results: Accuracy & Response Time

Accuracy. The repeated-measured ANOVA (RM-ANOVA) shows that the accuracy of thermal pattern identification was significantly affected by the pair of spots involved in the pattern (F(6,66)=7.75, p<0.0005, η2=0.413), but not the direction of temperature change. The post-hoc pair-wise comparison reveals that the patterns involving the front spots around both ears were perceived significantly more accurately than the others (p<0.05). The patterns with the back spots and the bottom spots of both ears yielded significantly lower accuracy than the others (p<0.05).

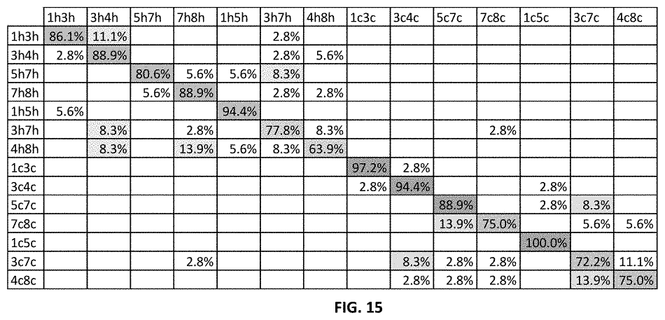

Considering the patterns that involve the spots around the same ear, the repeated-measured ANOVA was performed with the side of ear, the pair of spots, and the direction of temperature change as the independent variables. The results show that the perception accuracy was not significantly affected by any of these factors. FIG. 11 shows the average accuracy of the thermal pattern identification in Study 4, and FIG. 15 depicts the confusion table.

Response Time. Similar to previous studies, the analysis with a multi-factorial repeated measures ANOVA showed no significant effect of the type of pattern or the direction of temperature change on the response time, with the average value of 2.3 seconds (SD=0.72).

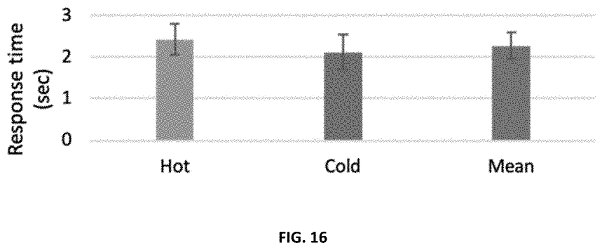

FIG. 16 illustrates the descriptive results of the response time in Study 4.

Discussion of Study 4

The set of fourteen spatial thermal patterns achieved an average accuracy of 85.3% in overall. The lowest accuracy was found for the pattern 4h8h, 63.8%, and its cold counterpart, 4c8c, also yielded a relatively low accuracy of 75.0%. Both of these patterns involve the area below the ear, which may have thicker skin and less hair than the other around-ear areas, leading to a lower thermal sensitivity as shown in Study 2 & 3. Different from these previous studies in which the area behind the ear yielded a high accuracy, the patterns with two stimuli behind the ear, 3h7h and 3c7c, resulted in relatively lower accuracy (3h7h: 77.8%, and 3c7c: 72.2%). Although both accuracies are above 70%, there is a large drop from their accuracy in Study 3. It may be because there were more confusion options against these two patterns in Study 4, whereas in Study 3 3h7h and 3c7c were the only patterns with the area behind the ear. Excluding the four aforementioned patterns with lower accuracy, the remaining 10 patterns achieved an average accuracy of 90.6%.

### INDUSTRIAL APPLICABILITY

ThermEarhook may be used along with a VR headset for an immersive gaming experience, such as feeling heat from a bomb blast or the cold feeling of the water splashing during a VR game. Thermal haptics may be used in the domain of virtual reality for enhancing the experience of the user in the virtual environment, game play, movie watching, etc. Thermal sense plays a significant role in the human recognition of environments and influences human emotions. ThermEarhook may be used to create a new emotional compatibility by combining auditory and thermal senses with its enhanced multipoint thermal feedback patterns. Further applications may be navigation related signals while cycling or riding a motorcycle, rather than the audio feedback from convention GPS which may not be heard in a loud environment. The thermal feedback facilitates hands-free navigation. In general, the ThermEarhook may be used in any application that involves the use of icons that signal the user of certain conditions or tasks to be performed. There is further application for hearing-impaired or visually-impaired individuals who need hands-free notifications.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A wearable device to convey notifications to users with thermal haptic feedback comprising:
an earhook shell configured to be worn on a user's outer ear, the earhook shell comprising a plurality of thermoelectric modules for providing hot and cold stimuli at multiple points on an auricular skin area of the user's outer ear;
a wireless receiver for receiving communication signals from a computing device; and
a power supply in electrical communication with the wireless receiver and the plurality of thermoelectric modules.

2. The wearable device of claim 1, wherein the power supply, the wireless receiver, and the plurality of thermoelectric modules are mounted on a printed circuit board.

3. The wearable device of claim 1, further comprising a controller in electrical communication with the power supply and the plurality of thermoelectric modules for controlling a temperature and a duration of the hot and cold stimuli.

4. The wearable device of claim 1, wherein the plurality of thermoelectric modules are Peltier modules.

5. The wearable device of claim 1, wherein the computing device is selected from a mobile phone, a personal computer (PC), a mainframe computer or a combination thereof.

6. The wearable device of claim 1, further comprising a thermally conductive heat sink layer mounting the plurality of thermoelectric modules.

7. The wearable device of claim 1, wherein the wireless receiver is selected from one or more of NFC, Bluetooth, Wi-Fi module or any combinations thereof.

8. The wearable device of claim 1, wherein the power supply is a rechargeable battery.

9. The wearable device of claim 1, further comprising one or more of a biosensor, a microphone, a bone conduction speaker, a GPS module, an accelerometer, and a gyroscope.

10. The wearable device of claim 3, wherein each of the plurality of thermoelectric modules is configured to be individually controlled by the controller.

11. The wearable device of claim 8, wherein the rechargeable battery includes connectors for external recharging.

12. The wearable device of claim 8, wherein the rechargeable battery is configured to be recharged through wireless recharging.

13. The wearable device of claim 10, wherein the plurality of thermoelectric modules comprises two or more of the thermoelectric modules, two or more of the thermoelectric modules are configured to be controlled together to create different thermal patterns.

14. The wearable device of claim 10, wherein the controller is configured to activate the thermoelectric modules for a duration ranging from 1-2 seconds through pulse-width modulation.
